(19) United States
(12) Patent Application Publication
(10) Pub. No.: US 2013/0048421 A1
(43) Pub. Date: Feb. 28, 2013

(54) SYSTEM FOR THE PROTECTION OF INDIVIDUALS WHO USE LADDERS

(71) Applicant: Søren Midtgaard, Copenhagen K (DK)

(72) Inventor: Søren Midtgaard, Copenhagen K (DK)

(21) Appl. No.: 13/578,992

(22) PCT Filed: Feb. 15, 2011
(86) PCT No.: PCT/EP2011/052187

§ 371 Date: Oct. 24, 2012

Related U.S. Application Data
(60) Provisional application No. 61/305,327, filed on Feb. 17, 2010.

(30) Foreign Application Priority Data
Feb. 16, 2010 (DK) PA 2010 70055

(51) Int. Cl. E06C 7/18

(52) U.S. Cl. 182/8

(57) ABSTRACT

The invention relates to a system for protecting individuals during work on ladders with steps. The system comprises an anti-fall protection device and a ladder climbing assistance device. The anti-fall protection device and ladder climbing assistance device are attachable to an individual by means of lines, safety harness or the like. The anti-fall protection device comprises a hinge for being secured on a guide means and anti-fall protection device and guide means are adapted to each other so that the anti-fall protection device is able to slide on the guide means when the hinge is influenced by a force in one direction and is securely locked on the guide means when the hinge is influenced by a force in another direction. The system comprises a breaking piece for insertion between worker and climbing assistance, which breaking piece and climbing assistance are adapted such to each other that the breaking piece is able to resist the force that occurs in normal use of the climbing assistance, but is broken in case of the increased force exercised on the climbing assistance by an individual when falling.

The invention relates to a system for the protection of individuals during work on ladders with steps, which system comprises an anti-fall protection device and a ladder climbing assistance device, said anti-fall protection device and ladder climbing assistance device being attachable to an individual by means of lines, safety harness or the like, said anti-fall protection device comprising a hinge for being secured on a guide means, said anti-fall protection device and guide means being adapted to each other so that the anti-fall protection device is able to slide on the guide means when the hinge is influenced by a force in one direction and is securely locked on the guide means when the hinge is influenced by a force in another direction.

When work is to be performed at great heights, eg during maintenance of wind turbines, it is often required that the person at work stands for long durations on internal or external ladder structures. On the one hand, the person performing such tasks is often to climb long distances on the ladders and, on the other hand, some of the work is also to be performed while standing on the ladders. The ascending and descending being in particular associated with physical strain, there is an increased risk of errors due to exhaustion and there is therefore a need for equipment that is not only reliable, but also unfailing and easy to operate and which may provide safety against individuals falling and which may also contribute in the sense that the strain on the worker is relieved.

Such ladder climbing assistance device devices for ladders are particularly useful in the context of ladders in wind turbines, masts, towers, silos, deep wells, etc. and are of great use, irrespective of where the maintenance and deployment crew is to carry tools or other ballast along during ascending or descending.

Often ladder climbing assistance devices comprise a line that forms a closed loop around a first wheel arranged at the upper end of the ladder and a second wheel which is arranged at the lower end of the ladder. A motor is provided at the upper end of the ladder and it is operatively engaged with the first wheel. Anytime an individual is to climb up or down the ladder, he couples onto the line by use of any expedient means, such as a clamp device which is in turn connected to a safety harness worn by the individual. Typically the ladder climbing assistance device “lifts/aids” with a limited force to the effect that individuals who use the climbing assistance device are able to overcome it.

The ladder climbing assistance device may be configured eg as described in European patent No. EP 1723305 B1.

European Patent No. EP 1608838 teaches a climbing aid whereby force between individual and climbing aid is regulated by means of a friction coupling.

Moreover, equipment for anti-fall protection devices used in the context of eg work on ladders is known. Such equipment may comprise an anti-fall protection device which may slide on a line.

From U.S. Pat. No. 5,265,696 a safety device is known which is intended for being clamped onto a cable/line.

In the known systems where both anti-fall protection device and a climbing assistance device are used it has been found that the climbing assistance device may influence the functionality of the anti-fall protection to the effect that the anti-fall protection is completely “incapacitated”. It has proved to be the case in particular when the anti-fall protection is mounted/slides on a line. Of course, that may be fatal to the individual using them as he/she is thereby not protected by the anti-fall protection.

There is therefore a need for a system that comprises both anti-fall protection and climbing assistance which may safeguard the functionality of the anti-fall protection.

The object of the invention is accomplished by means of a system that comprises a breaking piece for insertion between worker and climbing assistance, which breaking piece and climbing assistance are adapted such to each other that the breaking piece is able to resist the force that occurs in normal use of the climbing assistance, but is broken in case of the increased force exercised on the climbing assistance by an individual when falling.

By providing the system with a breaking line it is accomplished that, in case of a fall, an individual is released from the climbing assistance whereby the climbing assistance no longer affects the functionality of the anti-fall protection.

It should be emphasized that it is intended that the designation “line” as used in the present description should comprise any kind of flexible, elongate element capable of fulfilling the described function, ie that it comprises steel wires, rope, straps, chains an other flexible elongate elements.

The designation “hinge” comprises any kind of displaceable mechanism to which an individual may attach a line.

The invention further relates to a system as set forth in claims 3-4.

In the following, the invention will be described in further detail with starting point in the FIGURE, wherein

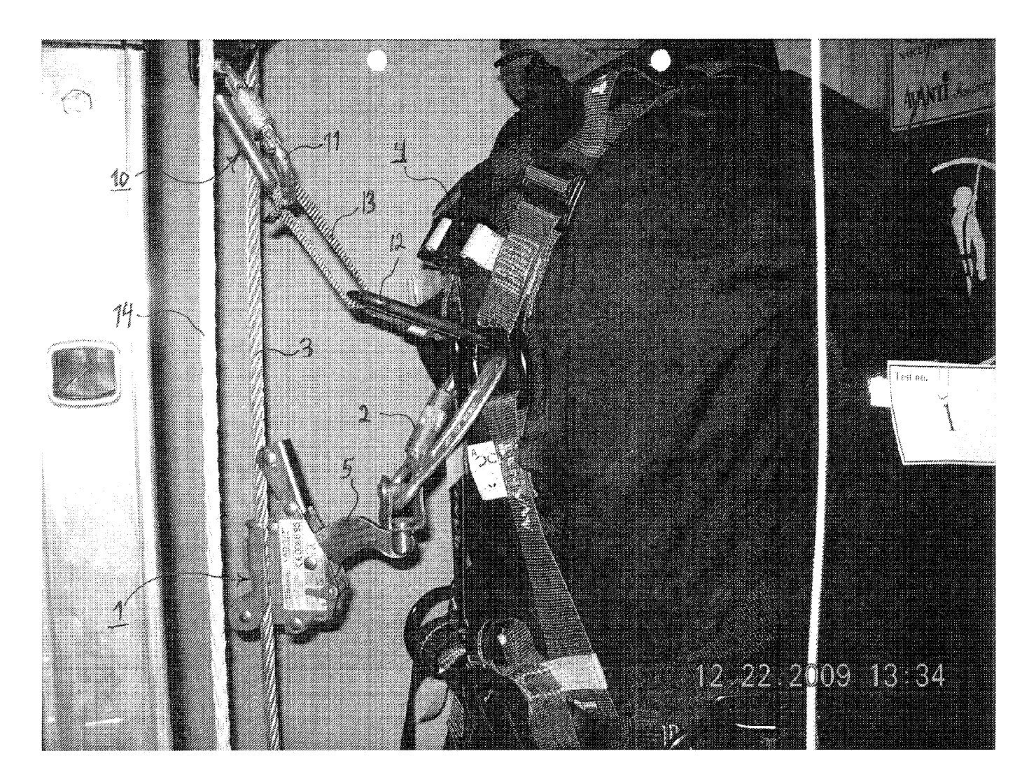

FIG. 1 is a perspective view of an embodiment of a system for anti-fall protection, wherein anti-fall protection and climbing assistance are mounted on a safety harness.

The system comprises an anti-fall protection (1) and a climbing assistance (10).

In the shown depiction, both anti-fall protection (1) and climbing assistance (10) are secured to a safety harness (4) which is used by workers maintaining eg wind turbines.

The anti-fall protection (1) is secured to the safety harness by means of a spring hook (2) which is connected to a hinge (5) on the anti-fall protection. The anti-fall protection is, in the shown embodiment, coupled to a wire (3) which acts as guide means, and anti-fall protection and wire are configured and adapted such to each other that the anti-fall protection is able to slide on the wire when the hinge is influenced by a force in one direction (which is, in the shown exemplary embodiment, upwards), and is securely locked on the wire when the hinge is influenced by a force in another direction.

The safety harness (4) is also secured to another wire (14) by means of another set of spring hooks (11, 12) that are also connected to each other via one breaking line (13). The function of the breaking line (13) will be explained in further detail below. The wire (14) is coupled to a motor (not shown) that supplies a force which is typically restricted to the effect that individuals using the climbing assistance are capable of overcoming it. Typically, such force will be of a magnitude of about 400 Newton to the effect that an individual using the climbing assistance will experience that his weight is reduced by about 40 kg.

By using both an anti-fall protection and a climbing assistance, it should thus be accomplished that an individual who used them was secure both in case of a fall and, simultaneously, he was assisted in both ascending and descending. However, it has been found that those systems do not operate entirely independently since the climbing assistance may influence the functionality of the anti-fall protection, which may be fatal to the user who is no longer secured against falling.

In normal use, the worker using the climbing assistance will be influenced by the force exercised by the climbing assistance which, as mentioned above, is typically in the magnitude of about 400 Newton. However, since the climbing assistance possesses some inertia, that force will briefly increase if the climbing assistance is exposed to swift influences. For instance if a worker suddenly loses his footing on his way up and falls. This is the discovery that is used to advantage in the present system since, in the connection between climbing assistance and worker (the safety harness), a breaking line is inserted that has a breaking strength exceeding the (normal) force of the climbing assistance, while simultaneously being below the force exercised if the climbing assistance is influenced swiftly.

Between the two spring hooks (11, 12) a line is thus, in the shown exemplary embodiment, inserted which line possesses the property that, upon a given impact, it breaks/ruptures and thereby releases the connection between safety harness and climbing assistance.

As described above, the climbing assistance will, in normal use, exercise a force of a magnitude of 400 Newton, which is why, in one embodiment, the breaking line has a breaking strength that exceeds same. According to one embodiment of the invention the line is broken when it is to lift about 110 kg.

According to one embodiment of the invention, the climbing aid comprises means that are able to increase the force that occurs between worker and climbing assistance if the speed between the two increases. Thereby the force maximally tolerated by the breaking line is increased whereby the risk of unintentional breakage is reduced.

If the climbing assistance comprises a line that forms a closed loop around a first wheel arranged at the upper end of the ladder and a second wheel arranged at the lower end of the ladder, the force between climbing assistance and safety harness/worker can be made to depend further on speed, eg by means of a magnet/or air drag (as known from eg rowing machines) which is inserted somewhere suitable on the line or at the wheels that drive the line. Such means can be used to advantage in particular in those kinds of climbing assistance that use either slide coupling or frequency converters for controlling/regulating the force with which the climbing assistance contributes.

Corresponding braking equipment is also known from eg lowering equipment used for lifeboats.

1. A system for protecting individuals during work on ladders with steps, said system comprising:
an anti-fall protection device; and
a ladder climbing assistance device,
wherein said anti-fall protection device and ladder climbing assistance device are attachable to an individual by means of lines or safety harness, wherein said anti-fall protection device comprises a hinge configured to be secured on a guide means, said anti-fall protection device and said guide means being adapted to each other so that the anti-fall protection device is able to slide on the guide means when the hinge is influenced by a force in one direction and is securely locked on the guide means when the hinge is influence by a force in another direction, wherein the system further comprises a breaking piece for insertion between the individual and the ladder climbing assistance device, wherein the breaking piece and the ladder climbing assistance device are adapted to each other such that the breaking piece is able to resist a force that occurs when the individual uses the ladder climbing assistance device to climb, and the breaking piece breaks under a force exercised on the ladder climbing assistance device that occurs when the individual falls.

2. The system for protecting individuals during work on ladders according to claim 1, wherein the guide means comprises a cable onto which the anti-fall protection is secured.

3. The system for protecting individuals during work on ladders according to claim 1, wherein the guide means comprises a rail onto which the anti-fall protection is secured.

4. The system for protecting individuals during work on ladders according to claim 1, wherein the breaking piece has a breaking strength in excess of 400 Newton.

5. The system for protecting individuals during work on ladders according to claim 1, wherein, in use, the climbing assistance imparts a force of about 400 Newton to the individual such that a weight of the individual using the ladder climbing assistance device is reduced by about 40 kg.

6. The system for protecting individuals during work on ladders according to claim 1, wherein the climbing assistance comprises means that increase the force between the individual and the climbing assistance in case the person falls.

7. The system for protecting individuals during work on ladders according to claim 1, wherein the ladder climbing assistance device comprises means that increase a force between the individual and ladder climbing assistance device if the individual falls; and that the breaking strength of the breaking piece is below that force.

8. The system for protecting individuals during work on ladders according to claim 1, wherein the breaking piece has a breaking strength that is above 1000 Newton.

9. The system for protecting individuals during work on ladders according to claim 1, wherein the breaking piece has a breaking strength that is above 1100 Newton.

10. The system for protecting individuals during work on ladders according to claim 2, wherein, in use, the ladder climbing assistance device imparts a force of about 400 Newton to the individual such that a weight of the individual using the climbing assistance is reduced by about 40 kg.

11. The system for protecting individuals during work on ladders according to claim 3, wherein, in use, the ladder climbing assistance device imparts a force of about 400 Newton to the individual such that a weight of the individual using the climbing assistance is reduced by about 40 kg.

12. The system for protecting individuals during work on ladders according to claim 4, wherein, in use, the ladder climbing assistance device imparts a force of about 400 Newton to the individual such that a weight of the individual using the climbing assistance is reduced by about 40 kg.

13. The system for protecting individuals during work on ladders according to claim 2, wherein the climbing assistance comprises means that increase the force between the individual and the climbing assistance in case the person falls.

14. The system for protecting individuals during work on ladders according to claim 3, wherein the climbing assistance comprises means that increase the force between the individual and the climbing assistance in case the person falls.

15. The system for protecting individuals during work on ladders according to claim 4, wherein the climbing assistance comprises means that increase the force between the individual and the climbing assistance in case the person falls.

16. The system for protecting individuals during work on ladders according to claim 5, wherein the climbing assistance comprises means that increase the force between the individual and the climbing assistance in case the person falls.

17. The system for protecting individuals during work on ladders according to claim 2, wherein the ladder climbing assistance device comprises means that increase a force between the individual and ladder climbing assistance device if the individual falls; and that the breaking strength of the breaking piece is below that force.

18. The system for protecting individuals during work on ladders according to claim 3, wherein the ladder climbing assistance device comprises means that increase a force between the individual and ladder climbing assistance device if the individual falls; and that the breaking strength of the breaking piece is below that force.

19. The system for protecting individuals during work on ladders according to claim 4, wherein the ladder climbing assistance device comprises means that increase a force between the individual and ladder climbing assistance device if the individual falls; and that the breaking strength of the breaking piece is below that force.

20. The system for protecting individuals during work on ladders according to claim 5, wherein the ladder climbing assistance device comprises means that increase a force between the individual and ladder climbing assistance device if the individual falls; and that the breaking strength of the breaking piece is below that force.
